(19) United States
(12) Patent Application Publication
(10) Pub. No.: US 2024/0246101 A1
(43) Pub. Date: Jul. 25, 2024

(54) COOLING HOLE AIR FLOW FOR THERMAL SPRAY COATINGS

(71) Applicants: Rolls-Royce Corporation, Indianapolis, IN (US); Rolls-Royce North American Technologies, Inc., Indianapolis, IN (US)

(72) Inventors: Matthew R. Gold, Indianapolis, IN (US); Kevin Sauer, Indianapolis, IN (US); Andrew Glucklich, Indianapolis, IN (US); Paul Raymond Melevage, Indianapolis, IN (US)

(21) Appl. No.: 18/417,605

(22) Filed: Jan. 19, 2024

Related U.S. Application Data
(60) Provisional application No. 63/480,806, filed on Jan. 20, 2023.

(51) Int. Cl. B05B 12/18; B05B 5/03; B05B 5/053; B05B 12/04; B05C 11/10

(52) U.S. Cl. CPC B05B 12/18; B05B 5/0533; B05B 12/04; B05C 11/10; B05B 5/032

(57) ABSTRACT

A suspension plasma spray deposition system comprising a suspension plasma spray device configured to deposit coating material on a surface of a component. The surface of the component includes a plurality of apertures. The system further includes a fluid flow system configured to flow fluid through the plurality of apertures in the surface of the component to reduce deposition of coating material in plurality of apertures. The fluid flow through each respective aperture of the plurality of apertures in the surface of the component is between about 0.095 and about 0.200 cubic feet per minute (cfm).

This application claims the benefit of U.S. patent Application No. 63/480,806, filed 20 Jan. 2023, the entire contents of which is incorporated herein by reference.

### TECHNICAL FIELD

The disclosure relates to systems and techniques for depositing coatings.

### BACKGROUND

Hot section components of a gas turbine engine may be operated in high temperature environments that may approach or exceed the softening or melting points of the materials of the components. Such components may include combustion components and/or air foils including, for example turbine blades or foils. The components may have one or more surfaces exposed to high temperature combustion or exhaust gases flowing across the surface of the competent. Different techniques have been developed to assist with cooling of such components including for example, application of a thermal barrier coating to the component, or adding cooling channels through a wall of the component and passing a cooling fluid, such as air, across or through a portion of the component to aid in cooling of the component. In some examples, cooling channels and application of a thermal barrier coating may be combined.

### SUMMARY

In general, the disclosure is directed to systems and techniques for forming coatings on components which define a plurality of apertures on a surface, such as cooling holes. More specifically, the disclosure is directed to systems and techniques for flowing fluid out of a plurality of apertures on a surface of the substrate while depositing coating material on the surface of the substrate via a suspension plasma spray process. Advantageously, suspension plasma spray processes use coating material with relatively small particle size relative to other coating processes. The path of the relatively small particle size of the coating material used in a suspension plasma spray process may be redirected by the flow of fluid out of the apertures, which may substantially reduce or prevent applying the coating material in or over the plurality of apertures in the surface of the substrate.

In some examples, the disclosure is directed to a suspension plasma spray deposition system. The system includes a suspension plasma spray device configured to deposit coating material on a surface of a component. The surface of the component includes a plurality of apertures. The system also includes a fluid flow system configured to flow fluid through the plurality of apertures in the surface of the component to reduce deposition of coating material in the plurality of apertures. The fluid flow through at least one aperture of the plurality of apertures in the surface of the component is from about 0.095 cubic feet per minute (cfm) to about 0.350 cfm, such as from about 0.095 cfm to about 0.200 cfm. Advantageously, fluid flow within the specified range may minimize or eliminate the deposition of coating material in or over the apertures defined by the surface, while also minimizing or eliminating disruption of the deposition of coating material in an aperture region defined on the surface.

In some examples, the disclosure is directed to a technique that includes depositing, via a suspension plasma spray device, coating material on a surface of a component. The surface of the component comprises a plurality of apertures. The technique further includes flowing, via a fluid flow system, fluid through the plurality of apertures in the surface of the component to reduce deposition of coating material in plurality of apertures. The fluid flow rate through at least one aperture of the plurality of apertures in the surface of the component is from about 0.095 cubic feet per minute (cfm) to about 0.350 cfm, such as about 0.095 cfm to about 0.200 cfm. Advantageously, fluid flow within the specified range may minimize or eliminate the deposition of coating material in or over the apertures defined by the surface, while also minimizing or eliminating disruption of the deposition of coating material in an aperture region defined on the surface.

### BRIEF DESCRIPTION OF THE DRAWINGS

FIG. 1 is a conceptual diagram illustrating an example system for forming a coating in a component which defines a plurality of apertures on a surface, according to some examples of the present disclosure.

FIG. 2A is a conceptual side view illustrating a portion of the system of FIG. 1, according to some examples of the current disclosure.

FIG. 2B is a conceptual top view illustrating a portion of the system of FIG. 1, according to some examples of the current disclosure.

FIG. 3 is a conceptual side view illustrating a portion of the system that corresponds to the view of FIG. 2, in which the system is operated outside the operating window described in the present disclosure.

FIG. 4 is a conceptual side view illustrating a portion of the system that corresponds to the view of FIG. 2, in which the system is operated outside the operating window described in the present disclosure.

FIG. 5 is a flow diagram illustrating an example technique for forming a coating on a surface of a substrate via suspension plasma spraying, according to some examples of the present disclosure.

### DETAILED DESCRIPTION

The disclosure describes systems and techniques for forming coatings, such as thermal barrier coatings, on surfaces of a component that has a plurality of apertures in the surface. Components such as hot gas section components of a gas turbine engine may have a plurality of apertures defined by a surface of the component. Such apertures may be cooling channels formed through a wall of the component which pass cooling fluid, such as air, across or through the component to aid in cooling of the component. Forming coatings on these components may be difficult because coatings formed on the surface may clog or plug the plurality of apertures in the surface, which may deleteriously reduce or eliminate the flow of fluid through the aperture during operation of the gas turbine engine, resulting in reduced lifespan of the component.

One way to address this problem involves masking or plugging the plurality of apertures prior to application of the coating. However, this process may be time-consuming, and may damage the coating during un-masking or unplugging of the channels. Alternatively, the coating may be formed on the surface, then the plurality of apertures may be manually cleared, laser ablated, or the like, to clear the plurality of apertures. This technique may yield similar challenges with respect to the significant time and effort required to unclog the plurality of apertures in the surface after formation of the coating.

Systems and techniques according to the present disclosure may minimize or eliminate infiltration of coating material into the plurality of apertures on the surface of the component by flowing fluid out of the apertures during deposition of the coating material. Advantageously, clogging or plugging of the plurality of apertures may be minimized or avoided, which may in turn minimize or eliminate the need to manually clear the apertures after deposition of the coating.

Flowing fluid out of a plurality of apertures on the surface during deposition of the coating may be difficult because the fluid (e.g., air) flowing out of the apertures has the potential to impact formation of the coating on the surface. For example, deposition of coating material through a conventional thermal spray process, (e.g., air plasma spray) may involve a coating material source with a median particle size on the order of 60 micrometers (μm). As such, the coating particles may have relatively high mass and relatively high momentum, and flowing fluid out of the plurality of apertures on the surface may not prevent coating material particles from entering an aperture. On the other hand, a relatively high pressure or flow rate of fluid through the apertures may cause deleterious effects on the resulting coating. For example, a high fluid flow rate may result in a bare spot on the surface or thinner layer of coating in a aperture region of the surface near an aperture of the plurality of apertures. Areas of thin or missing coating may result in reduced thermal resistance of the component in examples where the coating material is configured to form a thermal barrier coating.

Systems and techniques according to the present disclosure may advantageously provide for both minimized coating material in or over aperture in the surface and minimized disruptions or thickness variation on areas of the surface which do not define an aperture. The coating material may be deposited by suspension plasma spray, which may have a relatively small particle size relative to other thermal spray processes. For example, the coating material may have a median particle size (e.g., median particle diameter (D50)), of less than about 1 μm. These relatively light particles may have reduced momentum and thus may be redirected near the surface of the part by fluid flowing out of the plurality of apertures in the surface. The flow rate of fluid flowing out of each of the plurality of apertures may be about 0.095 cubic feet per minute (cfm) to about 0.350 cfm, such as from about 0.095 cfm to about 0.350 cfm. Flowing fluid out of at least one of the plurality of apertures formed in the surface at a flow rate within this range (e.g., 0.095 to 0.350 cfm) may advantageously minimize deposition of coating material in the plurality of apertures while simultaneously minimize disruptions in the deposition of coating material on the surface of the component where coating is desired to be applied. Flowing fluid at a rate higher than 0.350 cfm flow rate, or at a rate higher than about 0.200 cfm, may result in a bare spot on the surface or thinner layer of coating in a aperture region of the surface near an aperture of the plurality of apertures, while flowing fluid at a rate lower than 0.095 cfm may not prevent coating material particles from entering an aperture and clogging or plugging the aperture.

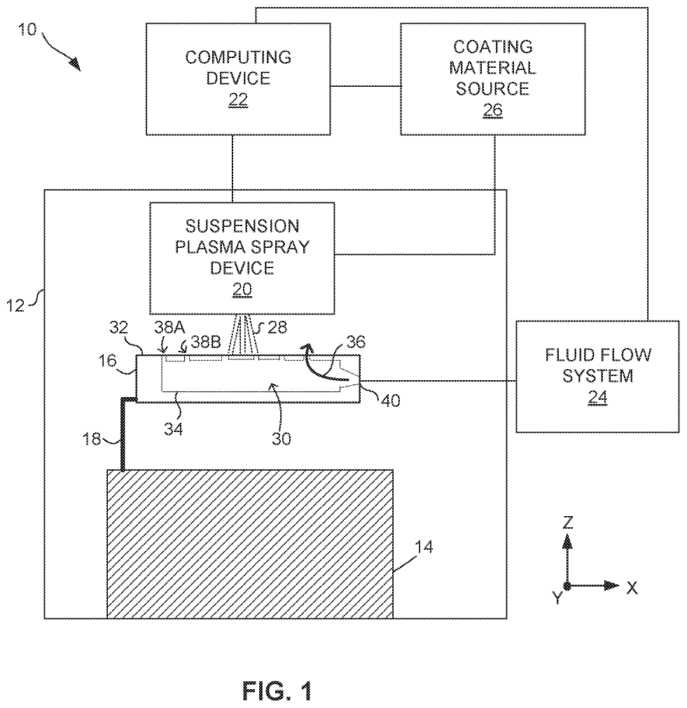

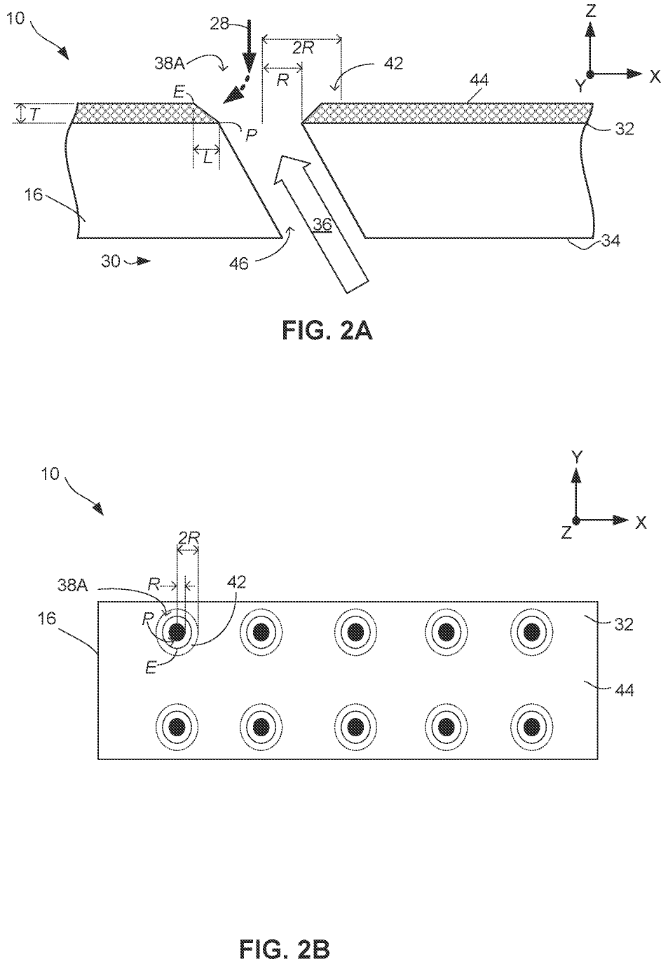

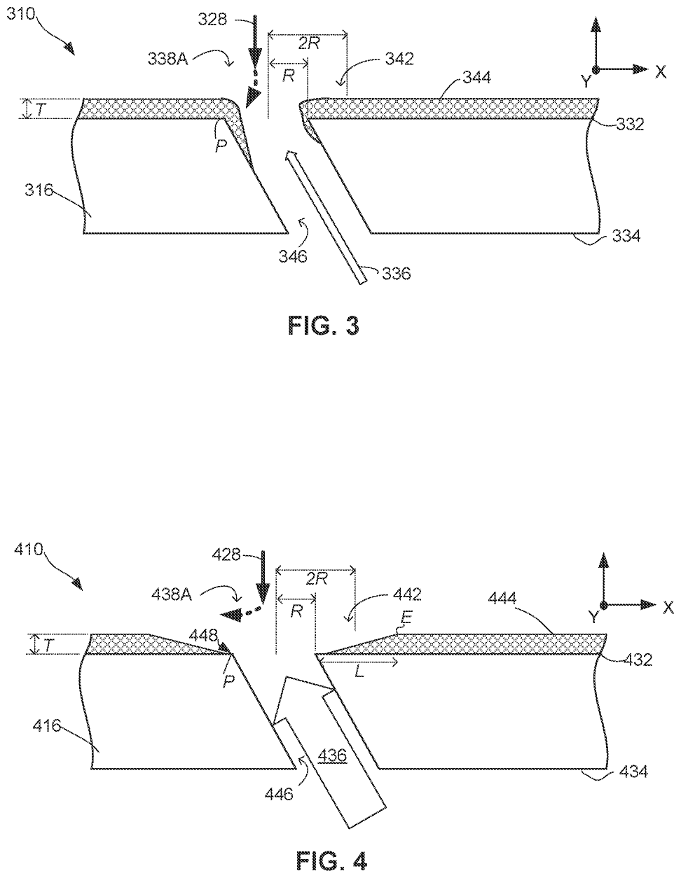

FIG. 1 is a conceptual and schematic diagram illustrating an example system 10 for forming a thermal barrier coating (TBC), or other coating layer such as an environmental barrier coating (EBC) using suspension plasma spray in accordance with some examples of the disclosure. FIGS. 2 and 3 illustrate magnified views of a portion of component 16 of system 10 of FIG. 1 for further understanding. FIGS. 3 and 4 illustrate magnified views similar to FIG. 2 for further understanding. In FIGS. 3 and 4, coating is deposited on components 316 in FIGS. 3 and 416 in FIG. 4, while systems 310 of FIGS. 3 and 410 FIG. 4 are operated outside of a desired operating window.

As shown in FIG. 1, system 10 may include chamber 12, stage 14 enclosed in chamber 12, and suspension plasma spray device 20. System 10 also includes fluid flow system 24, coating material source 26, and computing device 22. Component 16 is disposed in enclosure 12. In some examples, tool arm 18 may attach substrate 16 to stage 14.

Component 16 includes a plurality of apertures 38A, 38B (collectively “apertures 38”) formed on surface 32, which may be described as a first surface of component 16. Component 16 may also include an internal cavity 30 defined by inner surface 34 of substrate 16, which may be described as a second surface of component 16. Apertures 38 may extend from first surface 32 to second surface 34, forming cooling channels through a wall of component 16.

In some examples, chamber 12 may substantially enclose (e.g., enclose or nearly enclose) stage 14, substrate 16, and plasma spray device 20. Chamber 12 may be configured to establish a vacuum in chamber 12, for example through a vacuum pump. Alternatively, chamber 12 may be configured to be filled by a substantially inert atmosphere.

In some examples, tool arm 18 of stage 14 may be configured to selectively position and restrain component 16 in place relative to stage 14 and/or plume 28 of suspension plasma spray device 20 during formation of a coating (not shown), e.g., on first surface 32 of internal cavity 32. In other examples, system 10 may omit tool arm 18 and component 16 may be placed directly on stage 14. In some examples, stage 14 may be movable relative to suspension plasma spray device 20. For example, stage 14 may be translatable and/or rotatable along at least one axis to position component 16 relative to plasma spray device 20. Similarly, in some examples, plasma spray device 20 may be movable relative to stage 14 to position plasma spray device 20 relative to component 16.

Suspension plasma spray device 20 includes a device used to generate a plume 28 for use in the deposition of coating technique. For example, suspension plasma spray device 20 may include a plasma spray gun including a cathode and an anode (or nozzle) separated by a plasma gas channel. As the plasma gas flows through the plasma gas channel, a voltage may be applied between the cathode and anode to cause the plasma gas to form the plasma plume 28. In some examples, the coating material may be injected inside suspension plasma spray device 20 such that the coating material flows through part of the plasma gas channel. Although air plasma spray processes are also considered, suspension plasma spray device 20 may advantageously be configured to disperse coating material in a liquid carrier before injection into the plasma jet. In some examples, the liquid carrier may comprise or consist of water, ethyl alcohol, or a mixture thereof. In some examples, the coating material may be introduced to the plasma external to plasma spray device 20. Suspension plasma spraying may allow for the coating material to be a relatively fine powder (e.g., having a median particle size of less than about 5 micrometers, such as less than about 1 micrometers). The relatively fine powder may facilitate redirection of particles of coating material by fluid flowing out of apertures 38 in substrate 16. Relatively fine powders described herein may be too small for other plasma spray processes. Relatively fine powders as described herein may advantageously make it possible to generate uniform coating thicknesses and relatively thin coating layers relative to other thermal spray processes.

Coating material source 26 may include at least one source of material which is injected into the plasma plume 28 generated by plasma spray device 20 and deposited in a layer to form a coating on substrate 16. In some examples, the coating material may be in powder form, and may be supplied by coating material source 26 carried by a liquid carrier. In some examples, the coating material supplied by coating material source 26 may be referred to as the material feedstock or powder feedstock.

Fluid flow system 24 is configured to flow fluid 36 (e.g., air) out of apertures 38 in component 16 during deposition of coating material by suspension plasma spray device 20. Fluid flow system 24 may include one or more pumps, compressors or the like configured to supply fluid to component 16. In some examples, as illustrated in FIG. 1, component 16 may define internal cavity 30, accessed by opening 40, which may be sealed and pressurized by fluid flow system 24. In examples where component 16 does not define such an internal cavity, fluid flow system 24 may include components necessary to pressurize and seal portions of substrate 16 such that fluid may flow through apertures 38, including gaskets, hoses, chambers and the like. In some examples, the fluid provided by fluid flow system 24 may be regular “shop air” compressed at from about 50 pounds per square inch (psi) and about 150 psi, such as from about 100 psi to about 110 psi. In some examples, as illustrated, fluid 36 may flow through substrate 16 from second surface 34 to first surface 32 in a direction substantially opposite the direction of plume 28 impinging on first surface 32. In this way, the force of fluid 36 out of aperture 38A may direct coating material in plume 28 out of or away from aperture 38A to elsewhere on surface 32 or away from component 16 into chamber 12.

Computing device 22 may include, for example, a desktop computer, a laptop computer, a workstation, a server, a mainframe, a cloud computing system, or the like. Computing device 22 may include or may be one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some examples, the functionality of computing device 22 may be provided within dedicated hardware and/or software modules.

Computing device 22 is configured to control operation of system 10, including, for example, stage 14, suspension plasma spray device 20, and/or fluid flow system 24. Computing device 22 may be communicatively coupled to at least one of stage 14, suspension plasma spray device 20, and/or fluid flow system 24 using respective communication connections. Such connections may be wireless and/or wired connections.

Computing device 22 may be configured to control operation of stage 14 and/or suspension plasma spray device 20 to position component 16 relative to suspension plasma spray device 20. For example, as described above, computing device 22 may control suspension plasma spray device 20 to translate and/or rotate along at least one axis to position component 16 relative to plasma spray device 20.

Computing device 20 may control the voltage applied between the anode and cathode of suspension plasma spray device 20, a flow rate of powder and/or carrier liquid into suspension plasma spray device 20 or the plume 28, a flow rate of working gas into suspension plasma spray device 20, a standoff distance between plasma spray device 20, a pressure and/or flow rate of fluid 36 out of apertures 38 via fluid flow system 24, or the like, during the suspension plasma spray process to control one or more properties of the deposited coating 44.

As described above, system 10 may be configured to perform a coating technique to deposit a coating (not shown in FIG. 1) on surface 32 of component 16. The coating technique may be a suspension plasma spray technique, which may be a flexible process that allows relatively easy adjustment of process parameters to result in coatings with different chemistry, microstructure, or both. For example, computing system 22 of system 10 may control suspension plasma spray device 20 to deposit coating material at low angles on surface asperities on surface 32 of substrate 16, which may result in a coating with a columnar microstructure, in which the coating includes individual porous vertical columns. Coatings with columnar microstructure may have relatively high strain tolerance relative to other coatings, which may be advantageous for coatings of certain components.

In some examples, component 16 may include component of a high temperature mechanical system, such as a gas turbine engine. For example, component 16 may be part of a seal segment, a blade track, an airfoil, a blade, a vane, a combustion chamber liner, or the like. Component 16 may include inner surface 34 (illustrated in broken lines in FIG. 1) that defines internal cavity 30, which may be accessed through opening 40. In some examples, component 16 may have more than one opening to internal cavity 30. For example, component 16 may take the form of a tubular substrate (e.g., with a circular or rectangular cross-section) that has an opening on both ends of open cavity 30. In other examples, component 16 may only have a single opening 40 to access internal cavity 30.

In some examples, component 16 may include a ceramic or a CMC. Example ceramic materials may include, for example, silicon carbide (SiC), silicon nitride (Si₃N₄), alumina (Al₂O₃), aluminosilicate, silica (SiO₂), transition metal carbides and silicides (e.g. WC, Mo₂C, TiC, MoSi₂, NbSi₂, TiSi₂), or the like. In some examples, component 16 additionally may include silicon metal, carbon, or the like. In some examples, component 16 may include mixtures of two or more of SiC, Si₃N₄, Al₂O₃, aluminosilicate, silica, silicon metal, carbon, or the like.

In examples in which component 16 includes a CMC, component 16 may include a matrix material and a reinforcement material. The matrix material includes a ceramic material, such as, for example, silicon metal, SiC, or other ceramics described herein. The CMC may further include a continuous or discontinuous reinforcement material. For example, the reinforcement material may include discontinuous whiskers, platelets, fibers, or particulates. As other examples, the reinforcement material may include a continuous monofilament or multifilament weave. In some examples, the reinforcement material may include SiC, C, other ceramic materials described herein, or the like. In some examples, component 16 may include a SiC—SiC ceramic matrix composite.

Computing device 22 may be configured to control operation of system 10 to perform suspension plasma spray to deposit a coating (not shown in FIG. 1) onto first surface 32 of component 16. Example coatings include EBCs and TBCs. FIGS. 2A and 2B illustrate a close-up portion of substrate of FIG. 1 from a side view in FIG. 2A and a top view in FIG. 2B.

As shown by the magnified side view of a portion of substrate 16 in FIG. 2A, coating 44 may be formed by operating a system such as system 10 of FIG. 1 to perform a suspension plasma process to form coating 44 on surface 32 of component 16. As used herein, “formed on” and “on” mean a layer or coating that is formed on top of another layer or coating, and encompasses both a first layer or coating formed immediately adjacent a second layer or coating and a first layer or coating formed on top of a second layer or coating with one or more intermediate layers or coatings present between the first and second layers or coatings. In contrast, “formed directly on” and “directly on” denote a layer or coating that is formed immediately adjacent another layer or coating, e.g., there are no intermediate layers or coatings. In some examples, as shown in FIG. 2A, coating 44 may be directly on component 16. In other examples, one or more coatings or layers of coatings may be between coating 44 and component 16.

The composition of coating 44 may be controlled by the composition of coating material source 26. Coating 44 may take the form of a TBC configured to help protect component 16 from high temperatures encountered during operation of component 16 (e.g., in a gas turbine engine), or an EBC configured to help protect underlying component 16 from chemical species present in the environment the coated substrate is used, such as, e.g., water vapor, calcia-magnesia-alumina-silicate (CMAS; a contaminant that may be present in intake gases of gas turbine engines), or the like. Additionally, in some examples, coating 44 may also protect substrate 16 and provide for other functions besides that of a TBC or an EBC, e.g., by functioning as an abradable coating, erosion resistant coating, and/or the like.

Coating 44 may include at least one of a rare-earth oxide, a rare-earth silicate, an aluminosilicate, or an alkaline earth aluminosilicate. For example, coating 44 may include mullite, barium strontium aluminosilicate (BSAS), barium aluminosilicate (BAS), strontium aluminosilicate (SAS), at least one rare-earth oxide, at least one rare-earth monosilicate (RE₂SiO₅, where RE is a rare-earth element), at least one rare-earth disilicate (RE₂Si₂O₇, where RE is a rare-earth element), or combinations thereof. The rare-earth element in the at least one rare-earth oxide, the at least one rare-earth monosilicate, or the at least one rare-earth disilicate may include at least one of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), or scandium (Sc). For example, coating 44 may include silicon (Si), ytterbium disilicate (Yb₂Si₂O₇), ytterbium monosilicate (Yb₂SiO₅), yttrium disilicate (Y₂Si₂O₇), ytterium monosilicate (Y₂SiO₅), and/or mullite.

In some examples, a coating material provided by coating material source 26 may include additional and optional constituents of coating 44. For example, the additional and optional constituents coating 44 may include at least one rare earth disilicate may include BSAS, alumina, an alkali metal oxide, an alkaline earth metal oxide, TiO₂, Ta₂O₅, HfSiO₄, or the like. The additive may be added to the layer to modify one or more desired properties of the layer. For example, the additive components may increase or decrease the modulus of the layer, may decrease the reaction rate of the layer with calcia-magnesia-alumina-silicate (CMAS; a contaminant that may be present in intake gases of gas turbine engines), may modify the viscosity of the reaction product from the reaction of CMAS and constituent(s) of the layer, may increase adhesion of the layer to an adjacent layer, may increase the chemical stability of the layer, may decrease the steam oxidation rate, or the like.

Although coating 44 is shown as a single layer, in other examples, coating 44 may include multiple layers of the same or different compositions. In some examples, coating 44 may include an optional bond layer between coating 44 and surface 32 and may increase the adhesion of coating 44 to surface 32. In some examples, the bond layer may include silicon and take the form of a silicon bond layer. The bond layer may be in direct contact with substrate 16 and coating 44. In some examples, the bond layer has a thickness of about 0.001 inch (about 25.4 micrometers) to about 0.020 inch (about 254 micrometers), although other thicknesses are contemplated.

In examples in which component 16 includes a ceramic or CMC, the bond layer may include a ceramic or another material that is compatible with the material from which component 16 is formed. For example, the bond layer may include mullite (aluminum silicate, Al₆Si₂O₁₃), silicon metal or alloy, silica, a silicide, or the like. The bond layer may further include other elements, such as a rare earth silicate including a silicate of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), and/or scandium (Sc).

The composition of the bond layer may be selected based on the chemical composition and/or phase constitution of component 16 and the overlying layer (e.g., coating 44). For example, if substrate 16 includes a ceramic or a CMC, the bond layer may include silicon metal or alloy or a ceramic, such as, for example, mullite.

In some cases, a bond coat may include multiple layers. For example, in some examples in which component 16 includes a CMC including silicon carbide, component 16 may include a layer of silicon on component 16 and a layer of mullite, a rare earth silicate, or a mullite/rare earth silicate dual layer on the layer of silicon. In some examples, a bond coat 16 including multiple layers may provide multiple functions of bond coat 16, such as, for example, adhesion of substrate 16 to an overlying layer (e.g., EBC layer 18 of FIG. 1), chemical compatibility of bond coat 16 with each of substrate 16 and the overlying layer, a better coefficient of thermal expansion match of adjacent layers, or the like. In some examples, system 10 (FIG. 1) may be used to deposit the optional bond coat layer on surface 32 of component 16 using suspension plasma spray.

As illustrated in FIG. 2A, coating 44 may be formed to have any suitable thickness T, which may be uniform or nearly uniform across the surface 32 in areas which do not define an aperture 38A of apertures 38. For example, thickness T of coating 44 may be about 0.003 inches (about 76.2 micrometers) to about 0.020 inches (about 508 micrometers). In other examples, coating 44 may have a different thickness T.

As discussed above, substrate 16 includes a plurality of apertures 38, which fluid 36 is configured to flow fluid out of during operation of, for example, a gas turbine engine. Apertures 38 may be distributed evenly across surface 32, as shown in FIG. 2B, or may be randomly distributed, or may be distributed in clusters. Only a single aperture 38A is illustrated in the magnified view of FIG. 2A, but each other respective aperture may, in some examples, be described similarly as aperture 38A. Aperture 38A defined in surface 32 is an outlet of cooling channel 46 which fluidically connects first surface 32 and second surface 34, which is the inner surface of component 16 which defines inner cavity 30.

Fluid 36 is configured to flow through cooling channel 46 out of aperture 38A to reduce, minimize, or eliminate deposition of coating material in plume 28 by redirecting particles within plume 28 away from aperture 38A (as illustrated by the broken line in FIG. 2A). Coating material within plume 28 is directed elsewhere on surface 32 or away from component 16, so that cooling air may flow through cooling channel 46 while component 16 is in operation. Surface 32 defines perimeter P surrounding aperture 38A. In some examples, as illustrated, perimeter P may be substantially circular (e.g., circular or nearly circular). Additionally, or alternatively, at least one of apertures 38 may define another shape, such as an oval, ellipse, or slot. In some examples, the flow of fluid 36 through aperture 38A fluid may allow for deposition of the coating material on surface 32 outside of perimeter P, and substantially prevent deposition of the coating material inside perimeter P, where the coating material would clog or plug cooling channel 46. In some examples, fluid 36 may be air flowing at a rate of from about 0.095 cfm to about 0.350 cfm, such as about 0.95 cfm to about 0.200 cfm. Fluid 36 may be considered to flow at a rate of about X cfm when fluid 36 is flowing at X cfm +/−5%.

In some examples, such as where aperture 38A is substantially circular, aperture 38A defines a radius R from the center of aperture 38A to the boundary defined by surface 32. In some examples, aperture radius R may be from about 0.001 inches to about 0.020 inches, although other values are considered. An aperture region 42 surrounding aperture 38A may be defined on surface 32, which can be said to include the area of surface 32 surrounding aperture 38A within a distance of twice the radius R, 2R as illustrated in FIGS. 2A and 2B. In some examples, fluid 36 flowing out of aperture 38A may cause the thickness of coating 44 to increase as the distance from the center of aperture 38A increases along length L, from a relatively thin deposition of coating material at perimeter P to a point E where coating 44 reaches ultimate coating thickness T. In some examples, point E may be located within aperture region 42, such that length L is less than R. Stated similarly, the coating 44 may reach thickness T at a distance from the center of aperture 38A that is less than twice the radius R of aperture 38A, because the flow of fluid 36 may be selectively tailored to minimize deposition of coating material in cooling channel 46 while simultaneously minimizing the disruption of plume 28. Accordingly, suspension plasma spray device 20 may be configured to deposit a substantially constant thickness T of coating material on surface 32 outside of aperture region 42. Advantageously, bare spots or thin areas of coating 44 on surface 32 may thus be minimized, which may extend the useful life of component 16.

The flowrate of fluid 36 may be adjusted based on the size of aperture 38A. For example, the flowrate of fluid 36 between 0.095 cfm and about 0.350 cfm may be suitable for examples where aperture 38A has radius R of about 0.004 inches to about 0.008 inches, such as about 0.006 inches. As such, in some examples, the flowrate of fluid 36 out of aperture 38A may be defined in relationship to the area of aperture 38A on surface 32. In some examples, the flowrate of fluid 36 out of aperture 38A may be from about 8.0 cfm/square inch to about 32.0 cfm/square inch.

FIG. 3 illustrates example system 310 during a suspension plasma spray deposition of coating 344 on component 416. System 310 may be an example of system 10 of FIG. 1, where similar reference characters refer to similar elements. System 310 operates outside of the operating window of examples of the present disclosure. As such, system 310 is configured to flow fluid 336 at a flow rate of less than about 0.095 cfm. Because the flow rate of fluid 336 is relatively low, coating material in plume 328 may not be redirected, or may be redirected only slightly, as illustrated by the broken line in FIG. 3.

Accordingly, coating material from plume 328 may enter aperture 338A defined in surface 332, where it is deposited and adheres to the wall of cooling channel 346 to form part of coating 344 withing cooling channel 346. Deleteriously, operation of system 316 such that fluid 336 flows at less than 0.095 cfm out of aperture 338A results in coating 344 clogging cooling channel 336, which may lead to component 316 overheating during operation (e.g., in a gas turbine engine).

FIG. 4 illustrates example system 410 during a suspension plasma spray deposition of coating 444 on component 410. System 410 may be an example of system 10 of FIG. 1, where similar reference characters refer to similar elements. System 410 operates outside of the operating window of examples of the present disclosure. As such, system 410 is configured to flow fluid 436 at a flow rate of greater than about 0.350 cfm out of aperture 438A, which is configured to act as the outlet of cooling channel 446 during the suspension plasma spray process. Because the flow rate of fluid 436 is relatively high, coating material in plume 428 may be redirected significantly, as illustrated by the broken line in FIG. 3.

Accordingly, plume 428 may be disturbed, and deposition of coating material of surface 432 may be impacted and disrupted. Coating material 428 may be force away from outside of aperture region 442. Deleteriously, operation of system 416 such that fluid 436 flows at greater than about 0.200 cfm out of aperture 438A may result in coating bare spot 448 near perimeter P, which is an area of surface 432 that is not covered by coating 444. Additionally or alternatively, the relatively high flow rate of fluid 436 may result in point E being located out of aperture region 442, resulting in a relatively large area of coating 444 being less than the design thickness T, which may result in overheating of component 416 during operation (e.g., in a gas turbine engine).

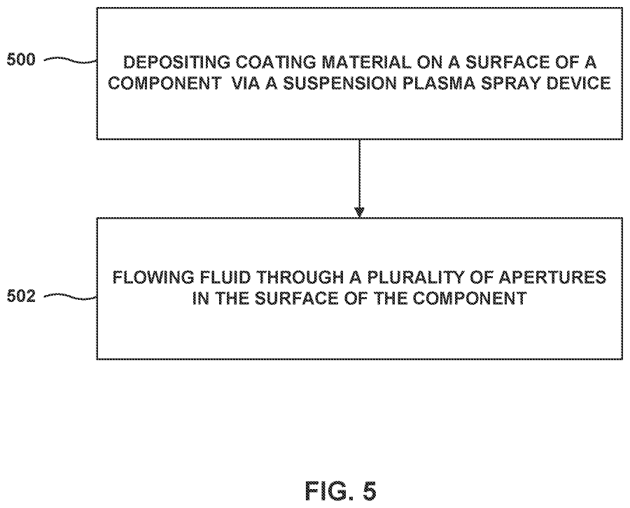

FIG. 5 illustrates an example technique for depositing a coating via a suspension thermal spray procedure, according to some examples of the present disclosure. The technique of FIG. 5 will be described with respect to system 10 of FIGS. 1-2B. It will be understood that system 10 may be used to perform other techniques, and other techniques may be used to apply coating 344 on component 16.

The technique of FIG. 5 includes depositing coating material on surface 32 of component 16 via suspension plasma spray device 20 (500). Component 16 may be a component of a gas turbine engine. In some examples, surface 32 of component 16 may be a first surface, and component 16 may define second surface 34 opposite first surface 32, and aperture 38A may defines an outlet of cooling channel 46 which fluidically connects first surface 32 and second surface 34 through component 16.

The technique of FIG. 5 also includes flowing, via fluid flow system 24, fluid 36 through a plurality of apertures 38 in surface 32 of component 16 to reduce deposition of coating material in the apertures 38 (502). The fluid flow rate through at least one aperture 38A of apertures 38 in surface 32 of the component is from about 0.095 cubic feet per minute (cfm) to about 0.350 cfm. In some examples, each respective aperture 38A of apertures 38 may define a perimeter P, and flowing fluid 36 through each respective aperture 38A of apertures 38 may allow for deposition of coating material on surface 32 outside of perimeter P, and substantially prevent (e.g., prevent or nearly prevent) deposition of the coating material inside the perimeter. In some examples, flowing fluid through the plurality of apertures comprises flowing air, although other gases, liquids, and combinations are considered. In examples where fluid 36 is air, the technique of FIG. 5 may include compressing the air to between about 50 pounds per square inch (psi) and about 150 psi. In some examples, flowing step 502 may include flowing fluid out of each respective aperture of apertures 38 in surface 32 of component 16 at a flow rate of from about 0.095 cfm to about 0.350 cfm, such as from about 0.095 cfm to about 0.200 cfm.

In some examples, aperture 38A may define perimeter P which has a substantially circular shape. Accordingly, aperture 38A may define an aperture radius R. In some examples, aperture radius R aperture radius of each respective aperture of the plurality of apertures may be from about 0.001 inches and about 0.020 inches. Surface 32 may define aperture region 42 surrounding aperture 38A. Aperture region 42 may include the area of surface 32 that lies with a distance from the center of aperture 38A that is less than two times the aperture radius R. In some examples, depositing coating material may include depositing a substantially constant thickness T of coating material on surface 32 outside aperture region 42.

In some examples, depositing step 500 and flowing step 502 may occur during overlapping time periods. In some examples, flowing step 502 may begin before depositing step 500, which may advantageously ensure fluid is flowing out of apertures 38 before deposition of coating material commences.

In some examples, the coating material may be configured to form coating 44 on surface 32, where coating 44 is a thermal barrier coating (TBC). Additionally, or alternatively, coating 44 may include one or more bond coat layers, one or more EBC layers, one or more abradable layers, or the like on surface 32 of component 16. In some examples, coating 44 may define a columnar microstructure. In some examples, the coating material may define a median particle size that is less than about 5 μm, such as less than about 1 μm. A relatively fine powder may advantageously be redirected by flowing fluid out of aperture 38 without significant disruption of plume 28.

In some examples, the technique of FIG. 5 further includes suspending the coating material in a liquid carrier. The liquid carrier may be ethyl alcohol, water, another liquid, or a mixture of two or more liquids.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

Various examples have been described. These and other examples are within the scope of the following clauses and claims.

Clause 1. A suspension plasma spray deposition system comprising: a suspension plasma spray device configured to deposit coating material on a surface of a component, wherein the surface of the component comprises a plurality of apertures; and a fluid flow system configured to flow fluid through the plurality of apertures in the surface of the component to reduce deposition of coating material in plurality of apertures, wherein the fluid flow through at least one aperture of the plurality of apertures in the surface of the component is from about 0.095 cubic feet per minute (cfm) to about 0.350 cfm.

Clause 2. The suspension plasma spray deposition system of clause 1, wherein each respective aperture of the plurality of apertures defines a perimeter, and wherein the fluid flow through each respective aperture of the plurality of apertures is configured to allow for deposition of the coating material on the surface outside of the perimeter, and substantially prevent deposition of the coating material inside the perimeter.

Clause 3. The suspension plasma spray deposition system of clause 2, wherein at least one aperture of the plurality of apertures defines a circular perimeter defining an aperture radius, wherein the surface defines an aperture region surrounding the aperture, wherein the aperture region includes the area of the surface within two times the aperture radius, wherein the suspension plasma spray device is configured to deposit a substantially constant thickness of coating material on the surface outside the aperture region.

Clause 4. The suspension plasma spray deposition of clause 3, wherein the aperture radius of each respective aperture of the plurality of apertures is between about 0.001 inches and about 0.020 inches.

Clause 5. The suspension plasma spray deposition system of any of clauses 1-4, wherein the coating material is configured to form a thermal barrier coating on the surface of the component.

Clause 6. The suspension plasma spray deposition system of any of clauses 1-5, wherein coating material is configured to form a coating which defines a columnar microstructure.

Clause 7. The suspension plasma spray deposition system of any of clauses 1-6, wherein coating material defines a median particle size that is less than about 1 micrometer (μm).

Clause 8. The suspension plasma spray deposition system of any of clauses 1-7, wherein the suspension plasma spray device is configured to suspend the coating material in a liquid carrier.

Clause 9. The suspension plasma spray deposition system of clause 8, wherein the liquid carrier is ethyl alcohol.

Clause 10. The suspension plasma deposition system of any of clauses 1-9, further comprising the component, wherein the surface of the component is a first surface, the component defines a second surface opposite the first surface, and wherein at least one aperture of the plurality of apertures defines an outlet of a cooling channel fluidically connecting the first surface and the second surface through the component.

Clause 11. The suspension plasma deposition of clauses 10, wherein the component is a component of a gas turbine engine.

Clause 12. The suspension plasma deposition of any of clauses 1-11, wherein the fluid configured to flow through the fluid flow system is air.

Clause 13. The suspension plasma deposition system of clause 12, wherein the air is compressed at between about 50 pounds per square inch (psi) and about 150 psi.

Clause 14. The suspension plasma deposition system of any of clauses 1-13, wherein the flow rate of fluid out of each respective aperture of the plurality of apertures in the surface of the component is between about 0.095 and about 0.350 cubic feet per minute (cfm).

Clause 15. A method comprising: depositing, via a suspension plasma spray device, coating material on a surface of a component, wherein the surface of the component comprises a plurality of apertures; and flowing, via a fluid flow system, fluid through the plurality of apertures in the surface of the component to reduce deposition of coating material in plurality of apertures, wherein the fluid flow rate through at least one aperture of the plurality of apertures in the surface of the component is from about 0.095 cubic feet per minute (cfm) to about 0.350 cfm.

Clause 16. The method of clause 15, wherein the depositing step and the flowing step occur during overlapping time periods.

Clause 17. The method of clause 16, wherein the flowing step begins before the depositing step.

Clause 18. The method of any of clauses 15-17, wherein each respective aperture of the plurality of apertures defines a perimeter, and flowing fluid through each respective aperture of the plurality of apertures allows for deposition of the coating material on the surface outside of the perimeter, and substantially prevents deposition of the coating material inside the perimeter.

Clause 19. The method of clause 18, wherein at least one aperture of the plurality of apertures defines a circular perimeter defining an aperture radius,

wherein the surface defines an aperture region surrounding the aperture, wherein the aperture region includes the area of the surface within two times the aperture radius, wherein depositing coating material comprises depositing a substantially constant thickness of coating material on the surface outside the aperture region.

Clause 20. The method of clause 19, wherein the aperture radius of each respective aperture of the plurality of apertures is between about 0.001 inches and about 0.020 inches.

Clause 21. The method of any of clauses 15-20, wherein the coating material is configured to form a thermal barrier coating on the surface of the component.

Clause 22. The method of any of clauses 15-21, wherein coating material is configured to form a coating which defines a columnar microstructure.

Clause 23. The method of any of clauses 15-22, wherein coating material defines a median particle size that is less than about 1 micrometer (μm).

Clause 24. The method of any of clauses 15-23, further comprising suspending the coating material in a liquid carrier.

Clause 25. The method of clause 24, wherein the liquid carrier is ethyl alcohol.

Clause 26. The method of any of clauses 15-25, wherein the surface of the component is a first surface, the component defines a second surface opposite the first surface, and wherein at least one aperture of the plurality of apertures defines an outlet of a cooling channel fluidically connecting the first surface and the second surface through the component.

Clause 27. The method of clause 26, wherein the component is a component of a gas turbine engine.

Clause 28. The method of any of clauses 15-27, wherein flowing fluid through the plurality of apertures comprises flowing air.

Clause 29. The method of clause 28, further comprising compressing the air to between about 50 pounds per square inch (psi) and about 150 psi.

Clause 30. The method of any of clauses 15-29, wherein flowing fluid through at least on aperture of the plurality of apertures comprises flowing fluid out of each respective aperture of the plurality of apertures in the surface of the component at a flow rate of from about 0.095 cfm to about 0.350 cfm.

What is claimed is:

1. A suspension plasma spray deposition system comprising:
a suspension plasma spray device configured to deposit coating material on a surface of a component, wherein the surface of the component comprises a plurality of apertures; and
a fluid flow system configured to flow fluid through the plurality of apertures in the surface of the component to reduce deposition of coating material in plurality of apertures, wherein the fluid flow through at least one aperture of the plurality of apertures in the surface of the component is from about 0.095 cubic feet per minute (cfm) to about 0.350 cfm.

2. The suspension plasma spray deposition system of claim 1, wherein each respective aperture of the plurality of apertures defines a perimeter, and wherein the fluid flow through each respective aperture of the plurality of apertures is configured to allow for deposition of the coating material on the surface outside of the perimeter, and substantially prevent deposition of the coating material inside the perimeter.

3. The suspension plasma spray deposition system of claim 2, wherein at least one aperture of the plurality of apertures defines a circular perimeter defining an aperture radius,
wherein the surface defines an aperture region surrounding the aperture, wherein the aperture region includes the area of the surface within two times the aperture radius,
wherein the suspension plasma spray device is configured to deposit a substantially constant thickness of coating material on the surface outside the aperture region.

4. The suspension plasma spray deposition of claim 3, wherein the aperture radius of each respective aperture of the plurality of apertures is between about 0.001 inches and about 0.020 inches.

5. The suspension plasma spray deposition system of claim 1, wherein the coating material is configured to form a thermal barrier coating on the surface of the component.

6. The suspension plasma spray deposition system of claim 1, wherein coating material is configured to form a coating which defines a columnar microstructure.

7. The suspension plasma spray deposition system of claim 1, wherein coating material defines a median particle size that is less than about 1 micrometer (μm).

8. The suspension plasma spray deposition system of any claim 1, wherein the suspension plasma spray device is configured to suspend the coating material in a liquid carrier.

9. The suspension plasma spray deposition system of claim 8, wherein the liquid carrier is ethyl alcohol.

10. The suspension plasma deposition system of claim 1, further comprising the component,
wherein the surface of the component is a first surface, the component defines a second surface opposite the first surface, and
wherein at least one aperture of the plurality of apertures defines an outlet of a cooling channel fluidically connecting the first surface and the second surface through the component.

11. The suspension plasma deposition of claim 1, wherein the component is a component of a gas turbine engine.

12. The suspension plasma deposition of claim 1, wherein the fluid configured to flow through the fluid flow system is air.

13. The suspension plasma deposition system of claim 12, wherein the air is compressed at between about 50 pounds per square inch (psi) and about 150 psi.

14. The suspension plasma deposition system of claim 1, wherein the flow rate of fluid out of each respective aperture of the plurality of apertures in the surface of the component is between about 0.095 and about 0.350 cubic feet per minute (cfm).

15. A method comprising:
depositing, via a suspension plasma spray device, coating material on a surface of a component, wherein the surface of the component comprises a plurality of apertures; and
flowing, via a fluid flow system, fluid through the plurality of apertures in the surface of the component to reduce deposition of coating material in plurality of apertures, wherein the fluid flow rate through at least one aperture of the plurality of apertures in the surface of the component is from about 0.095 cubic feet per minute (cfm) to about 0.350 cfm.

16. The method of claim 15, wherein the depositing step and the flowing step occur during overlapping time periods.

17. The method of claim 16, wherein the flowing step begins before the depositing step.

18. The method of claim 15, wherein each respective aperture of the plurality of apertures defines a perimeter, and flowing fluid through each respective aperture of the plurality of apertures allows for deposition of the coating material on the surface outside of the perimeter, and substantially prevents deposition of the coating material inside the perimeter.

19. The method of claim 18, wherein at least one aperture of the plurality of apertures defines a circular perimeter defining an aperture radius,
wherein the surface defines an aperture region surrounding the aperture, wherein the aperture region includes the area of the surface within two times the aperture radius,
wherein depositing coating material comprises depositing a substantially constant thickness of coating material on the surface outside the aperture region.

20. The method of claim 19, wherein the aperture radius of each respective aperture of the plurality of apertures is between about 0.001 inches and about 0.020 inches.
